(19) United States
(12) Patent Application Publication
(10) Pub. No.: US 2008/0174275 A1
(43) Pub. Date: Jul. 24, 2008

(54) Power supply method for electric apparatus

(75) Inventor: Tomoyuki Nakao, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/003,670

(22) Filed: Dec. 28, 2007

(30) Foreign Application Priority Data
Jan. 24, 2007 (JP) JP2007-013740

(51) Int. Cl. H02J 7/00

(52) U.S. Cl. 320/128; 320/135; 320/166

(57) ABSTRACT

An electric apparatus includes a plurality of circuit blocks, a plurality of power sources; and a plurality of power input portions receiving power in one-to-one correspondence with the plurality of circuit blocks, wherein the power sources are located in proximity to the power input portions and are connected to the power input portions.

### CROSS-REFERENCE TO RELATED APPLICATIONS

This application is based upon and claims the benefit of priority from the prior Japanese Patent Application No. 2007-13740 filed on Jan. 24, 2007, the entire contents of which are incorporated herein by reference.

### BACKGROUND OF THE INVENTION

1. Field of the Invention

The present invention relates to a method for suppressing radiation of electromagnetic wave noise in portable electric apparatuses.

2. Description of the Related Art

FIG. 1 is a block diagram showing the configuration of a conventional electric apparatus. The electric apparatus comprises a plurality of circuit blocks 10-1 through 10-3. The plurality of circuit blocks 10-1 through 10-3 receive power from a power circuit 300 through power line 320. The power circuit 300 is a constant voltage source which regulates voltage supplied to the circuit blocks 10-1 through 10-3 to a constant voltage. The high current supplied to the circuit block from the power circuit flows to a power supply line. As a result, the power supply line requires expansive wiring space in order to reduce line impedance. In turn, this expansive wiring space becomes an impediment to the miniaturization of portable apparatuses. Additionally high frequency current, generated by circuit block operations, flows in the power supply line. As a result, the problem occurs that the power supply line acts as an antenna, radiating electromagnetic wave noise into the air.

A known method for preventing the high frequency current noise generated by operations of the circuit blocks from flowing to a shared power supply line 320 is to suppress input voltage fluctuations from passing to a power supply line. The input voltage fluctuations may be suppressed by adding a voltage follower circuit to a power input portion of the circuit block, as disclosed in Japanese Unexamined Patent Application No. H11-103014. Additionally, Japanese Unexamined Patent Application No. H11-235018 discloses a distributed power supply system in which power circuits are provided on each circuit block in place of voltage follower circuits.

### SUMMARY

According to an aspect of an embodiment, an electric apparatus includes a plurality of circuit blocks, a plurality of power sources, and a plurality of input portions receiving power in one-to-one correspondence with the plurality of circuit blocks, wherein the power sources are located in proximity to the power input portions and are connected to the power input portions.

The above-described embodiments of the present invention are intended as examples, and all embodiments of the present invention are not limited to including the features described above.

### BRIEF DESCRIPTION OF THE DRAWINGS

FIG. 1 shows a conventional example.

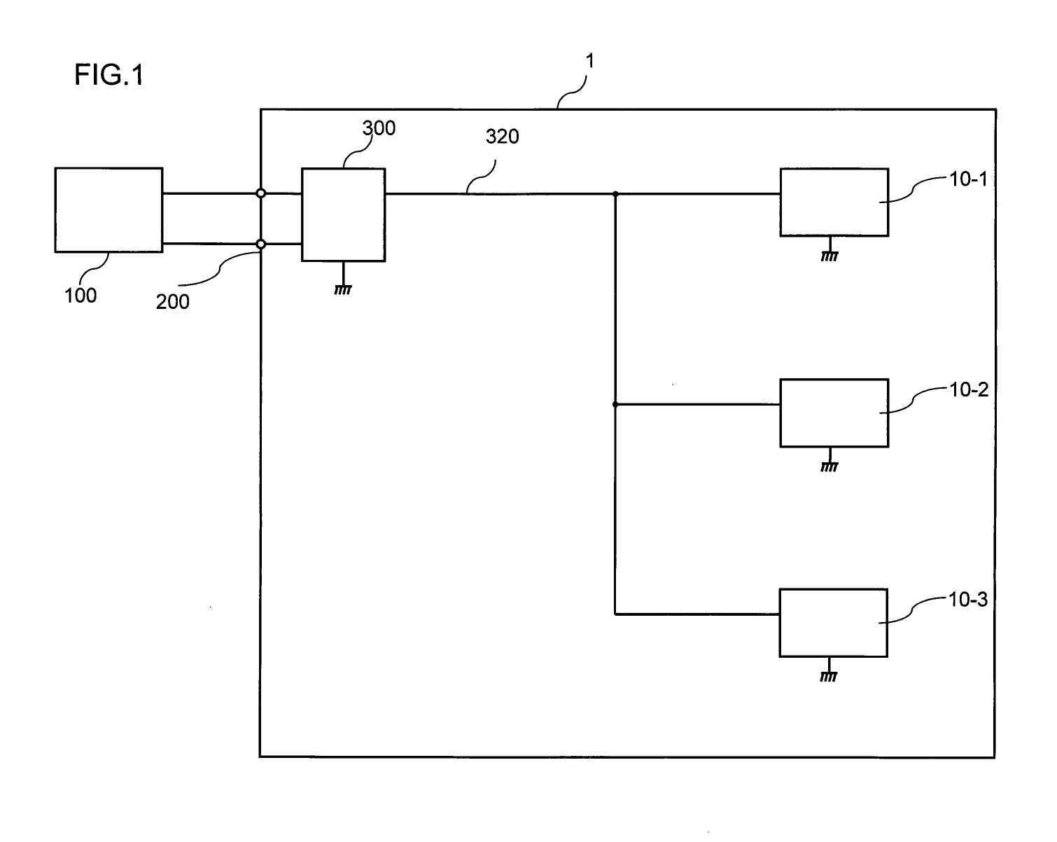

FIG. 2 shows a first embodiment of the present invention.

FIG. 3 shows a second embodiment of the present invention.

FIG. 4 shows a third embodiment of the present invention.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

The best embodiments of the present invention are described referring to the drawings. The following embodiments are described referring to the drawings. The following embodiments are illustrations, and the present invention is not limited to these embodiments.

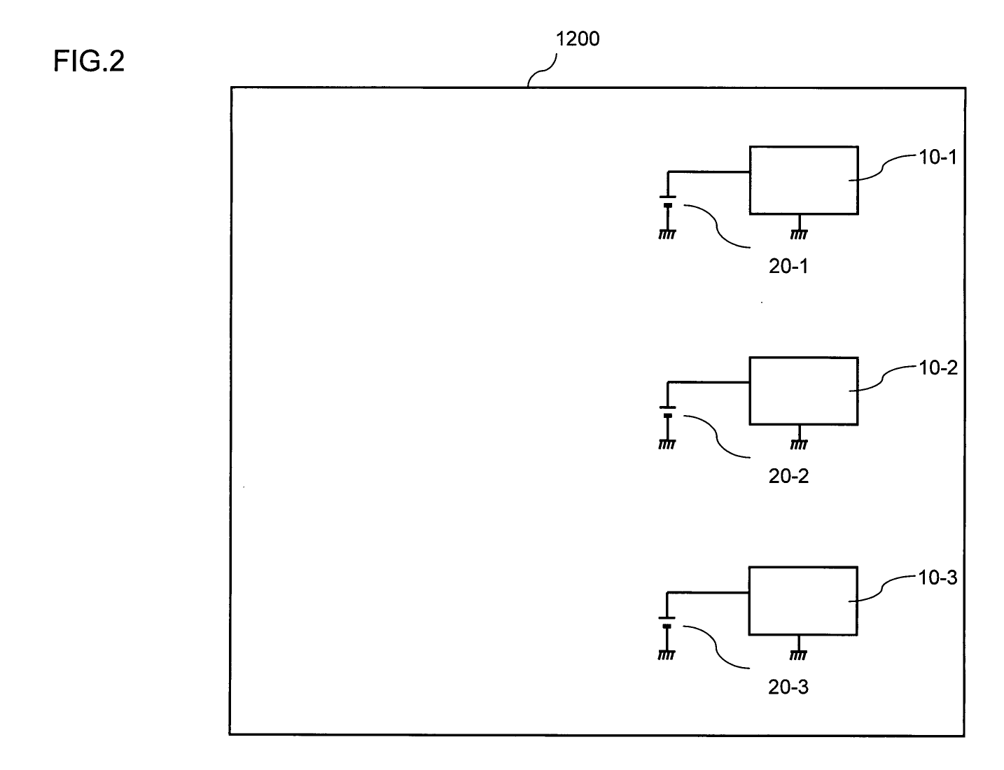

FIG. 2 is a configuration diagram of an electric apparatus 1200 which is a first embodiment of the present invention. The electric apparatus 1200 internally has a plurality of circuit blocks 10-1, 10-2, and 10-3 made up of large scale integrated circuits (LSI) or the like. Circuit blocks are connected with a signal lines (not shown in figure), and processing determined based on content of signals transmitted by the signal line is carried out.

The circuit blocks 10-1 through 10-3 are provided with a power input portion which receives supplied power. Also, batteries 20-1 through 20-3, which are power sources, are installed in proximity to the power input portion. The circuit blocks 10-1 through 10-3 receive power supplied from the batteries 20-1 through 20-3 via the power input portion. The circuit blocks 10-1 through 10-3 are, for example, complementary metal oxide semiconductor (CMOS) logic LSIs, and perform on-off logic operations in synchronization with a clock signal.

A CMOS logic circuit charges a metal oxide semiconductor (MOS) transistor gate with an electric load supplied from the power input portion to perform an ON operation and discharges the gate load to perform an OFF operation. As the charging and discharging operations of the MOS transistor gate are synchronous with the clock signal, the inflow of the gate charge current of the MOS transistor is generated at the frequency of the clock signal.

A high frequency current generated by the on-off operation of the CMOS logic circuit flows between the power source and the CMOS logic circuit. When the power source and a load, which is the CMOS logic circuit, are separated, the high frequency current flows in a power supply line which connects them and the power supply line acts as an antenna which radiates electromagnetic wave noise.

In contrast, an electric apparatus 1200 of the first embodiment has a battery installed for, and in proximity to, each CMOS logic circuit LSI. Therefore, the high frequency current flows in an extremely short loop and radiation of electromagnetic noise into the air is suppressed.

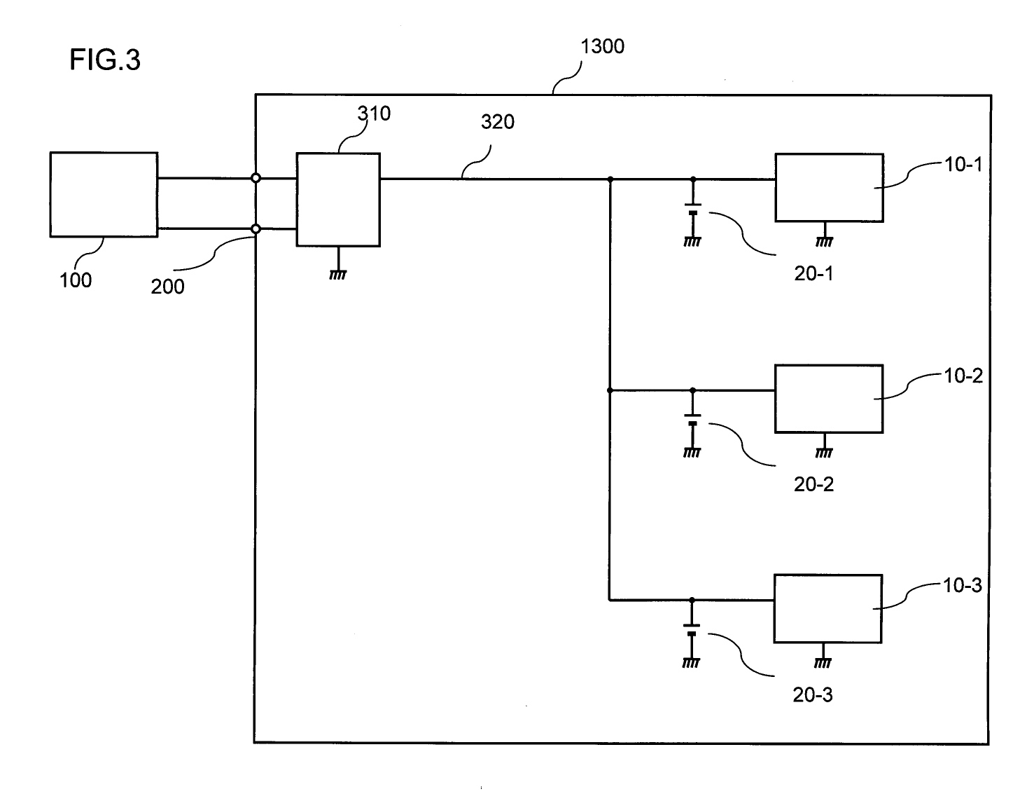

Next, an electric apparatus 1300 of a second embodiment will be explained with reference to FIG. 3.

In the first embodiment, a power supply installed in proximity and connected to the power source of the circuit block, such as an LSI, is a replaceable primary battery or charged secondary battery. When the battery dies it must be replaced with a new primary battery or charged secondary battery. It is possible to use a rechargeable secondary battery or a capacitor as the battery connected to the power input portion in order to avoid the nuisance of having to replace batteries. The rechargeable secondary battery or capacitor is installed in proximity to the circuit block, thereby making it possible to recharge without replacing batteries.

In addition to the configuration of the electric apparatus 1200 of the first embodiment, the electric apparatus 1300 of the second embodiment is further provided with a power supply line 320 for supplying charging current for charging the secondary batteries or capacitors installed as the batteries 20-1 through 20-3, a charging circuit 310 which charges the batteries 20-1 through 20-3 via the power supply line 320, and a power receiving terminal 200 for supplying power from an external power source to the charging circuit 310. Note that an external power source 100 is the external power source for supplying external power to the electric apparatus 1300.

In order to supply charging power to the secondary battery or capacitor, the charging circuit 310 has a DC-DC converter which outputs a constant current or constant voltage/constant current.

Problems such as heat generation and rapid deterioration in operating life may occur when charging the secondary battery or capacitor, unless the charging current is controlled to within the allowable levels. Therefore, the constant current output DC-DC converter controls the charging current depending on battery voltage to ensure that the charging current does not fluctuate and a constant current is achieved.

Additionally, when a lithium battery is used as the secondary battery, explosion, combustion, or rapid deterioration in operating life may result if charging is not performed within the allowable voltage for charging. Therefore, it is preferable to perform charging using a constant voltage/constant current output DC-DC converter.

In order to prevent heat generation or deterioration in operating life, the maximum current value of the charging current, which charges the secondary battery or capacitor, is restricted, but the minimum value is not restricted. When charged at 1 C, secondary batteries which charge using constant current such as NiCd batteries and NiMH batteries take approximately one hour to complete charging. However, when charged at 0.5 C, these batteries take approximately two hours to complete charging. The only difference when the current value of the charging current is lowered is that more time is required to charge.

When a lithium secondary battery is charged at 1 C, charging is completed in approximately two hours, and when charged at 0.5 C charging is completed in approximately 2.7 hours. Just as in the NiCd batteries and NiMH batteries, when the current value of the charging current is reduced, the time required to charge increases by a corresponding amount.

When supplying power to load logic circuits such as LSIs, unless the current required by the load is supplied, the load voltage will drop and the circuit (load) will perform maloperations. Therefore, the maximum current required by the load must flow to in power supply line.

Additionally, it is necessary to lower the impedance of the power supply line in order to suppress a voltage drop in the power supply line when maximum current is flowing. The line impedance of the power supply line is proportional to the length of the power supply line and inversely proportional to the cross-sectional area. The thickness of a copper wiring pattern of a multi-layer printed circuit board is approximately 17 μm, and is approximately 35 μm even if using a surface layer for the power supply-use line. The thickness of the copper wiring pattern is never more than 50 μm.

Conventionally, a width of 10 mm is necessary to realize 1 mΩ using a copper wiring pattern 17 μm thick and 10 mm long. In order to accommodate high currents a wide wiring space is necessary and this was an impediment to the miniaturization of portable apparatuses.

However, as stated above, the second embodiment lowers the current value for supplying charging current to the secondary batteries 20-1 through 20-3 from the charging circuit 310. As a result, a pattern width of the power supply line 320 can be narrowed and the electric apparatus 1 can be provided using a smaller wiring space.

Additionally, as the current flowing from the charging circuit 310 to the secondary batteries 20-1 through 20-3 is a constant current, only a magnetostatic field is generated at the power supply line 320 and electromagnetic wave noise is not radiated into the air from the power supply line 320.

Furthermore, it is preferable that the charging circuit 310 charges the secondary batteries 20-1 through 20-3 when the electric apparatus 1 is not operating.

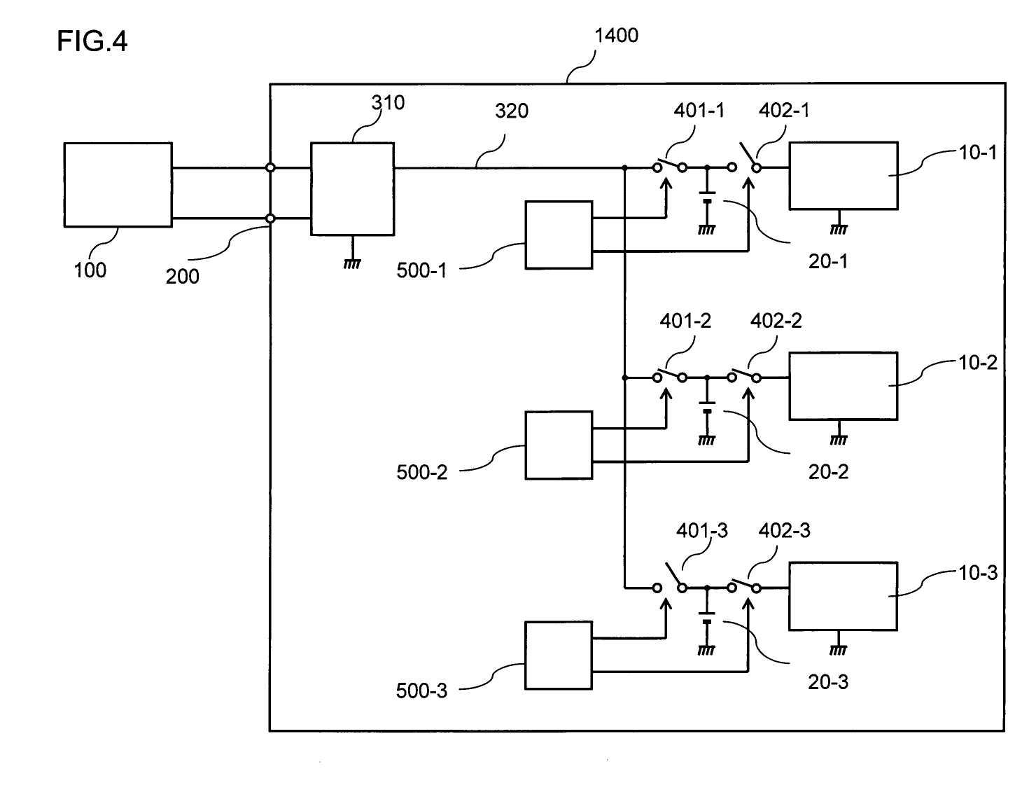

The following describes a third embodiment with reference to FIG. 4.

In the second embodiment, when a battery is installed as a power source at each CMOS logic circuit LSI forming an electric apparatus 1300 and any battery of the plurality of batteries is completely discharged, the electric apparatus 1300 can not operate even if there is sufficient power remaining in the other batteries. In order to eliminate this inconvenience, the remaining power of the batteries with sufficient power should be used to supplement the power of the batteries with little remaining power.

In addition to the electric apparatus 1300 of the second embodiment, the electric apparatus 1400 of the third embodiment is further provided with first switch circuits 401-1 through 401-3 installed on the wiring between the batteries or capacitors 20-1 through 20-3 and the charging circuit 310, second switch circuits 402-1 through 402-3 installed on the wiring between the batteries or capacitors 20-1 through 20-3 and the circuit blocks 10-1 through 10-3, and switch controllers 500-1 through 500-3. Energy saving for the electric apparatus 1400 can be realized by the third embodiment.

The switch controllers 500-1 through 500-3 are controllers which control the on-off state of the first switch circuits 401-1 through 401-3 and the second switch circuits 402-1 through 402-3. When an external power supply 100 is connected to a power receiving terminal 200 of the electric apparatus 1400, and the charging circuit 300 is operating, the switch controllers 500-1 through 500-3 operate so that the first switch circuits 401-1 through 401-3 are in the on state and the batteries 20-1 through 20-3 are charged.

The switch controllers 500-1 though 500-3 can detect, by the signal line (not shown in figure), if power is being supplied to the power receiving terminal 200 from external power supply 100 and if the charging circuit 310 is in operation. When the charging circuit 310 is in operation and any of the batteries 20-1 through 20-3 are fully charged (100% charged state) the switch controllers 500-1 through 500-3 switch off a first switch circuit corresponding to the fully charged battery, and in addition to stopping charging, cut off the power supply line 320 from the battery.

When the external power supply 100 is not connected to the power receiving terminal 200 of the electric apparatus 1400, or when the external power supply 100 is connected but the charging circuit 310 is not operating, the switch controllers 500-1 through 500-3 switch off the first switch circuits 401-1 through 401-3 and cut off the power supply line 320 from the batteries 20-1 through 20-3.

Hence, the first switch circuits 401-1 through 401-3 are installed between the batteries or capacitors 20-1 through 20-3 and the charging circuit 310, and, by using the first switch circuit to cut off the power supply line 320 from the batteries, the flow of high frequency current to the power supply line from the circuit block and resulting radiation of high frequency noise are prevented.

When the circuit blocks 10-1 through 10-3 of the electric apparatus 1400 are in an operating state, the switch controllers 500-1 through 500-3 switch on second switch circuits 402-1 through 402-3 and supply power to the circuit blocks 10-1 through 10-3. When any of the circuit blocks 10-1 through 10-3 of the electric apparatus 1400 are in a non-operating state, the switch controllers 500-1 through 500-3 switch off the second switch circuit of that non-operating circuit block, thereby reducing power consumption.

When the power of a battery corresponding to a circuit block is insufficient and the electric apparatus 1400 cannot continue operation, power from a battery with extra power is used to compensate. This is achieved by the switch controller switching on the first switch circuit corresponding to the battery with insufficient power and the first switch circuit of the battery with sufficient power so as to share the batteries.

As an example of this, a situation will be explained in which the circuit block 10-1 is in a non-operating state, the circuit blocks 10-2 and 10-3 are in an operating state, the power source 20-2 has insufficient power, and the power source 20-1 has extra power.

In a situation of this nature, the switch controllers 500-1 and 500-2 switch on the first switch circuits 401-1 and 401-2, the switch controller 500-3 switches off the first switch circuit 401-3, and the power source 20-1 compensates for power source 20-2.

At this point, since the circuit block 10-1 is in a non-operating state, the switch controller 500-1 switches off the second switch circuit 402-1 and, since the circuit blocks 10-2 and 10-3 are in an operating state, the switch controllers 500-2 and 500-3 switch on the second switch circuits 402-2 and 402-3.

As detailed above, when a battery is installed as a power source in each CMOS LSI that makes up an electric apparatus 1400 and any battery of the plurality of batteries is partially or even completely discharged, it is still possible to cause the electric apparatus 1400 to operate by utilizing other batteries with sufficient remaining power to compensate for the batteries with little remaining power.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electric apparatus, comprising:
a plurality of circuit blocks;
a plurality of power sources; and
a plurality of power input portions receiving power in one-to-one correspondence with the plurality of circuit blocks, wherein
the power sources are located in proximity to the power input portions and are connected to the power input portions.

2. The electric apparatus according to claim 1, wherein the power sources are batteries, and the batteries are installed in one-to-one correspondence with the circuit blocks.

3. The electric apparatus according to claim 2, further comprising:
a power receiving terminal receiving external power; and
a charging circuit, wherein
the charging circuit supplies, as a charging current to the batteries, a constant current which is smaller than a maximum current supplied to the circuit blocks by the corresponding batteries.

4. The electric apparatus according to claim 3, further comprising:
a first switch between each battery and the charging circuit;
a second switch between each battery and corresponding circuit block; and
a controller,
wherein the controller controls an on-off state of the first switch and the second switch based on operation of the charging circuit.

5. The electric apparatus according to claim 4, wherein:
the plurality of circuit blocks consists of at least a first circuit block and a second circuit block, and
the controller turns off the second switch connected to the first circuit block, turns on the first switch connected to the first circuit block, and turns on the first switch and the second switch connected to the second circuit block when the first circuit block is in a non-operating state and the second circuit block is in an operating state.

6. The electric apparatus according to claim 1, wherein the power sources are capacitors installed in one-to-one correspondence with the circuit blocks.
